(19) United States
(12) Patent Application Publication
(10) Pub. No.: US 2017/0228228 A1
(43) Pub. Date: Aug. 10, 2017

(54) REMOTE LAUNCH OF DEPLOY UTILITY

(71) Applicant: Quanta Computer Inc., Taoyuan City (TW)

(72) Inventor: Wen-Hua LIN, Taoyuan City (TW)

(21) Appl. No.: 15/016,634

(22) Filed: Feb. 5, 2016

(51) Int. Cl. G06F 9/445; H04L 29/08; H04L 12/24

(52) U.S. Cl. CPC G06F 8/61; H04L 41/0806; H04L 67/02; H04L 67/06

(57) ABSTRACT

A method for remotely launching a deployment utility includes booting up a server and performing a power-on self-test (POST). The server determines a location of the deployment utility stored on a remote server. The server retrieves the deployment utility from the remote server, based on the location, and executes the deployment utility

### BACKGROUND

Field

This application relates to computer systems, and more particularly to a system and method for remotely launching a deployment utility for installing an operating system or firmware on a server.

Background

Deploying a new operating system on a large number of server systems can be a complex and time consuming task. One way that operating system deployment can occur is to have a system administrator physically visit each of the machines in the organization and physically install the new operating system. This approach is a very time consuming task. In organizations with large numbers of machines that are to be upgraded, this approach is not practicable.

Deploy agents are used to install operating system in server systems. Traditionally, a deployment agent is either pre-installed in a local server storage or an image including the deployment agent is downloaded from the internet before the deploy agent can be launched. A typical image that includes the deployment agent also includes installation files for multiple operating systems and is therefore very large.

Pre-installing deployment agents in local server storage increases hardware cost for the server storage. Further, the deployment agent is often not up to date and may not support the newest or latest features. Additionally, downloading an updated deployment utility from the internet may be time consuming due to the large size of the typical image that includes the deployment agent.

### SUMMARY

The following presents a simplified summary of one or more embodiments in order to provide a basic understanding of present technology. This summary is not an extensive overview of all contemplated embodiments of the present technology, and is intended to neither identify key or critical elements of all examples nor delineate the scope of any or all aspects of the present technology. Its sole purpose is to present some concepts of one or more examples in a simplified form as a prelude to the more detailed description that is presented later.

In some implementations, a method for remotely launching a deployment utility includes booting up a server and performing a power-on self-test (POST). The server determines a location of the deployment utility stored on a remote server. The server retrieves the deployment utility from the remote server, based on the location, and executes the deployment utility.

In some implementations, the server stores a Unified Extensible Firmware Interface (UEFI) bootable image to a UEFI bootable media, where booting up the server executes a script file on the UEFI bootable image comprising instructions for retrieving the deployment utility.

In some implementations, a baseboard management controller (BMC) of the server configures, using an Intelligent Platform Management Interface (IPMI) command, to request the server to retrieve the deployment utility on a next boot up.

In some implementations, the deployment utility installs an operating system to the server. In some implementations, the deployment utility installs firmware on the server.

In some implementations, retrieving the deployment utility is by UEFI using iPXE or gPXE. In some implementations, retrieving uses at least one of Hypertext Transfer Protocol (HTTP), File Transfer Protocol, Internet Small Computer System Interface (iSCSI), or ATA over Ethernet (AoE) to transfer data from the remote server. In some implementations, booting up includes loading an iPXE image and an embedded script from a bootable image, to update iPXE or gPXE settings.

In some implementations, retrieving the deployment utility is by UEFI using Preboot eXecution environment (PXE) protocol. In some implementations, retrieving uses a Trivial File Transfer Protocol (TFTP) to transfer data from the remote server.

In some implementations, a system for remotely launching a deployment utility includes a network interface card (NIC) and a Unified Extensible Firmware Interface (UEFI). The UEFI is configured to: perform a power-on self-test (POST), determine a location of the deployment utility stored on a remote server, command the NIC to retrieve the deployment utility from the remote server, based on the location, and execute the deployment utility.

In some implementations, the system further includes a UEFI bootable media storing a bootable image, where booting up the system executes a script file on the UEFI bootable image comprising instructions for retrieving the deployment utility.

In some implementations, the system further includes a baseboard management controller (BMC) configured to use an Intelligent Platform Management Interface (IPMI) command to request the UEFI to retrieve the deployment utility on a next boot up.

### BRIEF DESCRIPTION OF THE DRAWINGS

These and other sample aspects of the present technology will be described in the detailed description and the appended claims that follow, and in the accompanying drawings, wherein:

FIG. 1A illustrates an example method for remotely launching a deployment utility;

FIG. 1B illustrates optional steps to the method for remotely launching a deployment utility of FIG. 1A;

FIG. 2 illustrates a block diagram of an example system for remotely launching a deployment utility; and

FIG. 3 illustrates a block diagram of an example computer system.

### DETAILED DESCRIPTION

The subject disclosure provides techniques for power management of a server rack. Various aspects of the present technology are described with reference to the drawings. In the following description, for purposes of explanation, numerous specific details are set forth in order to provide a thorough understanding of one or more aspects. It is evident, however, that the present technology can be practiced without these specific details. In other instances, well-known structures and devices are shown in block diagram form in order to facilitate describing these aspects.

The subject disclosure provides a method for remotely launching a deployment utility for installing an operating system or firmware on a server. The deployment utility is retrieved from a remote server through a network such as the Internet. The server executes the deployment utility to install the operating system or firmware without needing to download or store the deployment utility in advance.

An operating system is system software that manages computer hardware and software resources and provides common services for computer programs. The operating system is a component of the system software in a computer system. Application programs usually require an operating system to function.

Firmware is software that residing in non-volatile memory chips that hold their content without power. Firmware is found on computer motherboards to hold hardware settings and booting data. Firmware typically contains only elementary basic functions of a device and may only provide services to higher-level software.

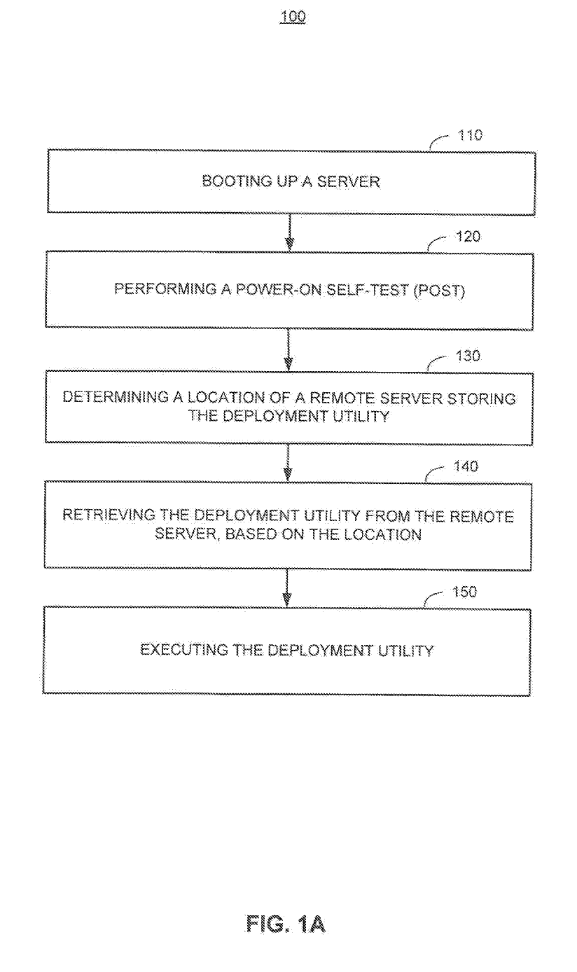

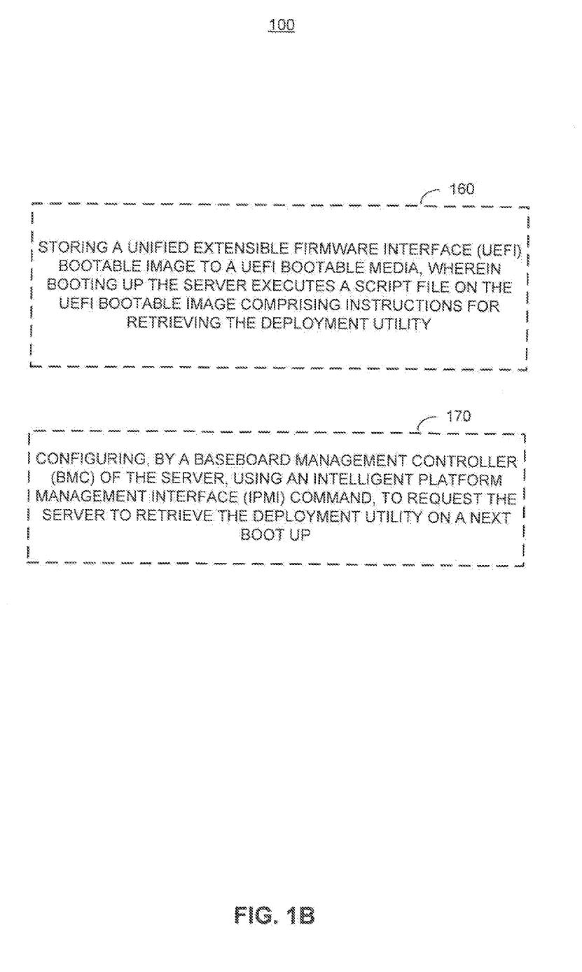

FIG. 1A illustrates an example method 100 for remotely launching a deployment utility to install an operating system or firmware on a server. In some implementations, the method is by an Extensible Firmware Interface (EFI) or Unified Extensible Firmware Interface (UEFI) of the server.

UEFI is a specification that defines a software interface between an operating system and platform firmware. UEFI was developed as a replacement for Basic Input/Output System in IBM personal computers. UEFI stores all the information about initialization and startup in an .efi file. The .efi file is stored on a storage device inside a special partition called EFI System Partition (ESP). The ESP partition also contains boot loader programs for the operating system.

At step 110, the server is booted up. For example, the server may be powered on or power cycled/reset by an administrator. The server can be booted either directly or remotely over a network.

At step 120, the server can perform a power-on self-test (POST). The POST process verifies and tests functionality of various hardware components such as central processing unit (CPU) registers, hard disk drives, optical reading devices, cooling devices, memory modules, expansion cards and the like.

At step 130, the server determines a location of the deployment utility stored on a remote server. For example, the location of the deployment utility can be an HTTP address stored into a non-volatile storage or storage device of the server. For example, the HTTP address can be entered by an administrator in an UEFI setup menu, or a default address may be stored into the UEFI during manufacturing. Storing the deployment utility on the remote server allows the server to not store the deployment utility locally and further makes keeping the deployment utility up-to-date easier. For example the remote server can be a Trivial File Transfer Protocol (TFTP) server, a Hypertext Transfer Protocol (HTTP) server, or a File Transfer Protocol (FTP).

The deployment utility (also known as a deployment agent) is a software program that prepares the server for installing the operating system or firmware. The deployment utility is typically a memory-resident, minimalistic software that can initialize storage devices (e.g., hard disk drives (HDDs) or solid state drives (SSDs)) and transfer disk images and files. Disk images, are computer files containing the contents and structure of a disk volume or an entire data storage device, such as a hard disk drive, tape drive, floppy disk, optical disc or USB flash drive. A disk image is usually made by creating a sector-by-sector copy of the source medium, thereby perfectly replicating the structure and contents of a storage device independent of the file system. Depending on the disk image format, a disk image may span one or more computer files. Disk image file formats may be open standards, such as the ISO image format for optical disc images, or proprietary to particular software applications.

The deployment utility allows an administrator to choose between different configurations options for Redundant Array of Independent Disks (RAID), device drivers, utilities, or other installation options for the operating system. Some deployment utilities can provide a user interface to allow the administrator to input choices for the different configurations.

At step 140, the server retrieves the deployment utility from the remote server, based on the location of the remote server. For example, the remote server can be accessed by the server through a local area network (LAN) such as Ethernet, Wi-Fi, or Bluetooth, or a wide area network such as the Internet. In some implementations, the deployment utility is downloaded from the remote server to system memory and/or storage device of the server. No operating system image needs to be downloaded.

In some implementations, UEFI uses Preboot eXecution Environment (PXE) to retrieve the deployment utility from the remote server. In some implementations, UEFI uses iPXE or gPXE protocol to retrieve the deployment utility from the remote server. Both iPXE and gPXE are an open-source implementation of the PXE client firmware and bootloader. iPXE or gPXE enables computers (i.e., clients) without built-in PXE support to boot from the network, or to extend an existing PXE client implementation so it supports additional protocols.

PXE specification describes a standardized client-server environment that boots a software retrieved from a network on PXE-enabled servers. On the client side it requires only a PXE-capable network interface controller (NIC), and uses Dynamic Host Configuration Protocol (DHCP) and TFTP. DHCP is a standardized network protocol used on Internet Protocol (IP) networks for dynamically distributing network configuration parameters, such as IP addresses for interfaces and services. TFTP is a lock-step, File Transfer Protocol which allows a client to get from or put a file onto a remote host.

In some implementations, UEFI uses iPXE or gPXE to retrieve the deployment utility from the remote server. Unlike PXE which uses Trivial File Transfer Protocol (TFTP) to transfer data, iPXE and gPXE retrieves remote data using Transmission Control Protocol/Internet Protocol (TCP/IP, also known as Internet protocol suite) such as HTTP and FTP, or Internet Small Computer Systems Interface (iSCSI), ATA over Ethernet (AoE), or Fibre Channel over Ethernet (FCoE).

TCP/IP is the computer networking model and set of communications protocols used on the Internet and similar computer networks. TCP/IP provides end-to-end connectivity specifying how data should be packetized, addressed, transmitted, routed and received at the destination. TCP/IP functionality is organized into four abstraction layers.

iSCSI is used to facilitate data transfers over intranets and to manage storage over long distances. SCSI can be used to transmit data over local area networks (LANs), wide area networks (WANs), or the Internet and can enable location-independent data storage and retrieval.

In some implementations, booting up the server includes loading an iPXE image and an embedded script from a bootable image, to update iPXE or gPXE settings. For example, the bootable image can be an optical disc ISO image to be run by the UEFI during boot. For example, the iPXE image can be loaded into the NIC' s memory.

At step 150, the server executes the deployment utility. The server is able to execute the deployment utility to install the operating system or firmware without needing to download or store the deployment utility in advance. Version 2.5 of the UEFI specification adds support for accessing boot images over Hypertext Transfer Protocol (HTTP).

FIG. 1B illustrates optional steps to the method for remotely launching a deployment utility of FIG. 1A.

At optional step 160, the server stores a Unified Extensible Firmware Interface (UEFI) bootable image to a UEFI bootable media, wherein booting up the server executes a script file on the UEFI bootable image comprising instructions for retrieving the deployment utility. For example, the script file can function to enter or to update the location of the deployment utility on the remote server into the UEFI or iPXE settings.

For example, the script file can include instructions for UEFI to use PXE, iPXE, or gPXE to retrieve and execute the deployment utility from the remote server. The script file can include location information of the remote server and the deployment utility on the remote server. At step 162, the server stores the UEFI shell bootable image to a UEFI bootable media, wherein booting up the server executes the script file from the UEFI bootable media.

At optional step 170, a BMC, using an Intelligent Platform Management Interface (IPMI) command, requests the server to retrieve the deployment utility on a next boot up. For example, the BMC can send an IPMI command, including specified locations of the remote server and deployment utility, to change settings on UEFI HTTP boot that causes the UEFI to use iPXE to retrieve the deployment utility from the specified locations. The baseboard management controller (BMC) is microcontroller that manages interfaces between system management software and platform hardware. In some implementations, each BMC can manage hardware components within the server, such as processors, memory, storage devices, PSUs, fans, boards, etc.

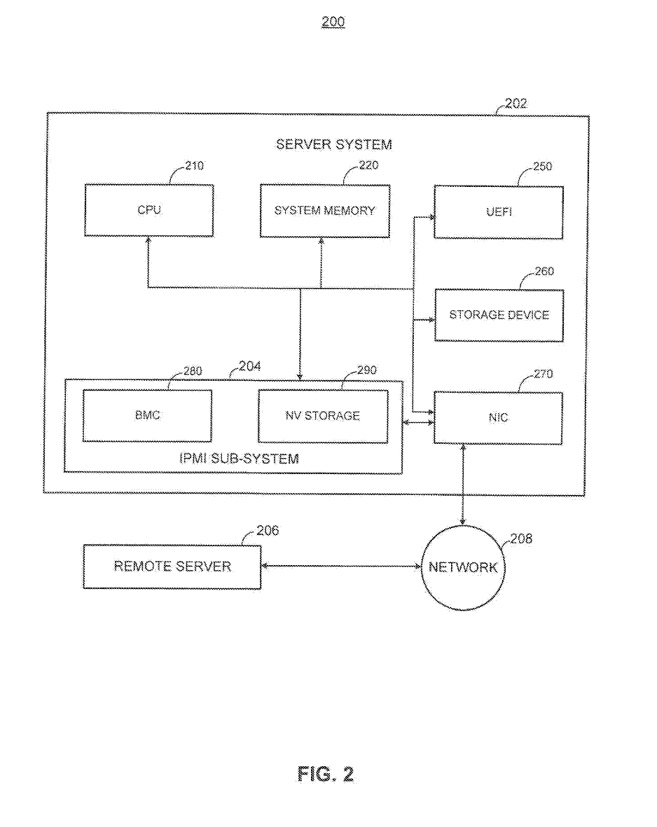

FIG. 2 illustrates a block diagram of an example system 200 for remotely launching a deployment utility. The system 200 includes a server 202, a network 208 and a remote server 206.

The remote server 206 can be any computer device connected to the network 208 for storing a deployment utility and one or more operating systems or firmware to be installed to the server 202. For example the remote server can be a Trivial File Transfer Protocol (TFTP), HTTP, or FTP server. The deployment utility is a software program that prepares the server 202 for installing an operating system.

The server 202 includes a central processing unit (CPU) 210, system memory 220, a UEFI 250, a storage device 260, a network interface controller (NIC) 270, and an IPMI sub-system 204. The server 202 is booted up, by for example, being powered on or power cycled/reset by an administrator. The server 202 can be booted either directly or remotely over the network 208.

The UEFI 205 stores all the information about initialization and startup in an .efi file. The .efi file is stored on the storage device 260 inside a special partition called EFI System Partition (ESP).

After booting up, the UEFI 250 of the server 202 performs POST. The UEFI 250 includes instructions executed when the server 202 is first powered on. The POST process verifies and tests functionality of various hardware components such as central processing unit (CPU) registers, hard disk drives, optical reading devices, cooling devices, memory modules, expansion cards and the like.

The UEFI 250 of the server 202 determines a location of the deployment utility stored on a remote server. For example, the location of the deployment utility can be an HTTP address stored into the storage device 260 of the server 202. In some implementations, the HTTP address can be entered by an administrator in an UEFI setup menu.

The UEFI 250 of the server 202 retrieves the deployment utility from the remote server, based on the location. The UEFI 250 connects to the remote server 206 through the network 208 using the NIC 270. In some implementations, the NIC 270 can connect to the remote server using TCP/IP.

In some implementations, the NIC 270 supports PXE, which allows the UEFI 250 to retrieve the deployment utility over the network 208. The NIC 270 that supports PXE uses TFTP to retrieve the deployment utility from the remote server 206.

If the NIC 270 does not support PXE, the NIC 270 can use iPXE or gPXE to allow the UEFI 250 to retrieve the deployment utility over the network 208. The NIC 270 applying iPXE or gPXE uses HTTP and FTP, iSCSI, AoE, or FCoE to retrieve the deployment utility from the remote server 206. In some implementations, the server 202 stores a Unified Extensible Firmware Interface (UEFI) bootable image to the storage device 260, where booting up the server 202 executes a script file on the UEFI bootable image comprising instructions for retrieving the deployment utility.

In some implementations, the deployment utility is downloaded from the remote server 206 to the system memory 220 and/or the storage device 260. No operating system image needs to be downloaded.

The UEFI 250 executes the deployment utility from the remote server 206 to install an operating system or firmware on storage device 260 of the server 202. For example, the UEFI 250 can execute the deployment utility stored on the system memory 220 and/or storage device 260. In some implementations, the UEFI 250, when executing the deployment utility, installs a selected operating system stored on the remote server 206. Files and/or images for non-selected operating systems or firmware do not need to be downloaded from the remote server 206.

The IPMI sub-system 204 includes the BMC 280, a non-volatile storage 290, and other satellite controllers (not shown) distributed among different system modules. The IPMI sub-system 204 can operate independent of the rest of the server 202 and can function even when the server 202 is powered down or shut off. The IPMI sub-system 204 and the NIC 270 can operate even on standby power or in a low-power mode while the server 202 is shut down.

The satellite controllers within the same chassis connect to the BMC via Intelligent Platform Management Bus (IPMB), an implementation of Inter-Integrated Circuit (IIC or I²C) protocol. The IIC protocol features a multi-master, multi-slave, single-ended, serial computer bus that uses a Serial Data Line and a Serial Clock Line with a 7-bit or a 10-bit address space.

The BMC 280 is a microcontroller that manages interfaces between system management software and platform hardware. In some implementations, each BMC 280 can manage hardware components within the server 202, such as processors, memory, storage devices, PSUs, fans, boards, etc.

The BMC 280 communicates with the various server components that the BMC 280 manages using the IPMI protocol. IPMI is a set of specifications for an autonomous computer subsystem that manages and monitors a computer system's CPU, firmware, and OS, and for out-of-band management and monitoring by system administrators. The BMC 280 can connect to the various server components (e.g., southbridge 240 or NIC 270) using any bus interface such as the system management bus (SMBus), RS-232 serial bus, IIC protocol, Ethernet, IPMB, low-pin count (LPC) bus, etc. The IIC protocol features a multi-master, multi-slave, single-ended, serial computer bus that uses a Serial Data Line and a Serial Clock Line with a 7-bit or a 10-bit address space. The SMBus protocol features a single-ended, two-wire bus derived from IIC protocol and uses IIC hardware and IIC addressing. The IPMB is an IIC based serial bus for connecting various boards within the server.

The BMC 280 connects to the network 208 using the NIC 270. The NIC 270 allows an administrator to remotely manage the BMC 280 over the network 208. The network 208 can be, for example, a local area network (LAN) such as Ethernet, Wi-Fi, or Bluetooth, or a wide area network such as the Internet. The network 208 can be a telecommunications network that allows network nodes to exchange data along network links. For example, the network 208 can be an Ethernet, a type of wired LAN protocol described by a set of standards together called IEEE 802.3.

In some implementations, the BMC 280, using an IPMI command, can request the server 202 to retrieve the deployment utility on a next boot up. For example, the BMC 280 can send an IPMI command, including specified locations of the remote server and deployment utility, to change settings on UEFI HTTP boot that causes the UEFI 250 to use iPXE to retrieve the deployment utility from the specified locations.

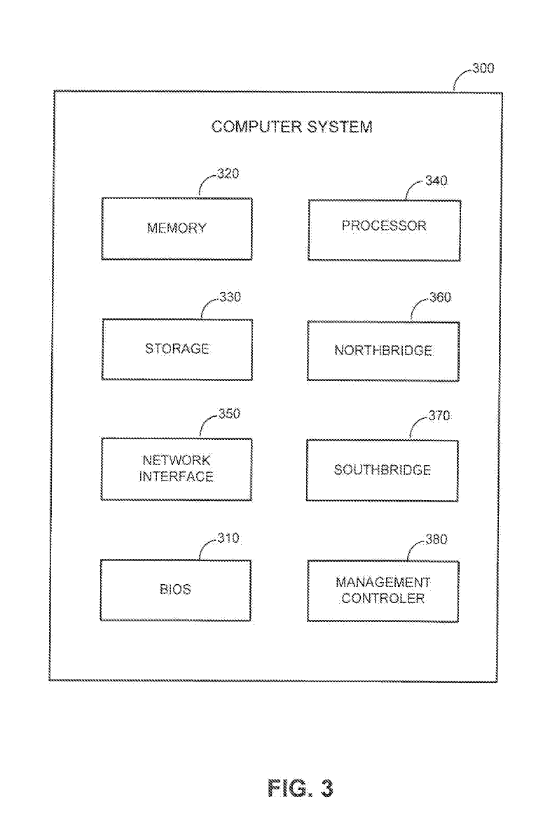

FIG. 3 illustrates a block diagram of an example computer system 300. The computer system 300 includes a processor 340, a network interface 350, a management controller 380, a memory 320, a storage 330, a BIOS 310, a northbridge 360, and a southbridge 370.

The computer system 300 is, for example, a server (e.g., a server in a server rack of a data center) or a personal computer. The processor (e.g., central processing unit (CPU)) 340 is a chip on a motherboard that retrieves and executes programming instructions stored in the memory 320. The processor 340 is a single CPU with a single processing core, a single CPU with multiple processing cores, or multiple CPUs. One or more buses (not shown) transmit instructions and application data between various computer components such as the processor 340, memory 320, storage 330, and networking interface 350.

The memory 320 includes any physical device used to temporarily or permanently store data or programs, such as various forms of random-access memory (RAM). The storage 330 includes any physical device for non-volatile data storage such as a HDD or a flash drive. The storage 330 can have a greater capacity than the memory 320 and can be more economical per unit of storage, but can also have slower transfer rates.

The BIOS 310 includes a Basic Input/Output System or its successors or equivalents, such as an Extensible Firmware Interface (EFI) or Unified Extensible Firmware Interface (UEFI). The BIOS 310 includes a BIOS chip located on a motherboard of the computer system 300 storing a BIOS software program. The BIOS 310 stores firmware executed when the computer system is first powered on along with a set of configurations specified for the BIOS 310. The BIOS firmware and BIOS configurations are stored in a non-volatile memory (e.g., NVRAM) or a ROM such as flash memory. Flash memory is a non-volatile computer storage medium that can be electronically erased and reprogrammed

The BIOS 310 is loaded and executed as a sequence program each time the computer system 300 is started. The BIOS 310 recognizes, initializes, and tests hardware present in a given computing system based on the set of configurations. The BIOS 310 performs self-test, such as a Power-on-Self-Test (POST), on the computer system 300. This self-test tests functionality of various hardware components such as hard disk drives, optical reading devices, cooling devices, memory modules, expansion cards and the like. The BIOS addresses and allocates an area in the memory 320 in to store an operating system. The BIOS 310 then gives control of the computer system to the OS.

The BIOS 310 of the computer system 300 includes a BIOS configuration that defines how the BIOS 310 controls various hardware components in the computer system 300. The BIOS configuration determines the order in which the various hardware components in the computer system 300 are started. The BIOS 310 provides an interface (e.g., BIOS setup utility) that allows a variety of different parameters to be set, which can be different from parameters in a BIOS default configuration. For example, a user (e.g., an administrator) can use the BIOS 310 to specify clock and bus speeds, specify what peripherals are attached to the computer system, specify monitoring of health (e.g., fan speeds and CPU temperature limits), and specify a variety of other parameters that affect overall performance and power usage of the computer system.

The management controller 380 is a specialized microcontroller embedded on the motherboard of the computer system. For example, the management controller 380 is a baseboard management controller (BMC). The management controller 380 manages the interface between system management software and platform hardware. Different types of sensors built into the computer system report to the management controller 380 on parameters such as temperature, cooling fan speeds, power status, operating system status, etc. The management controller 380 monitors the sensors and has the ability to send alerts to an administrator via the network interface 350 if any of the parameters do not stay within preset limits, indicating a potential failure of the system. The administrator can remotely communicate with the management controller 380 to take some corrective action such as resetting or power cycling the system to restore functionality.

The northbridge 360 is a chip on the motherboard that can be directly connected to the processor 340 or is integrated into the processor 340. In some instances, the northbridge 360 and the southbridge 370 is combined into a single die. The northbridge 360 and the southbridge 370, manage communications between the processor 340 and other parts of the motherboard. The northbridge 360 manages tasks that require higher performance than the southbridge 370. The northbridge 360 manages communications between the processor 340, the memory 320, and video controllers (not shown). In some instances, the northbridge 360 includes a video controller.

The southbridge 370 is a chip on the motherboard connected to the northbridge 360, but unlike the northbridge 360, need not be directly connected to the processor 340. The southbridge 370 manages input/output functions, such as Universal Serial Bus (USB), audio, serial, BIOS, Serial Advanced Technology Attachment (SATA), Peripheral Component Interconnect (PCI) bus, PCI eXtended (PCI-X) bus, PCI Express bus, ISA bus, SPI bus, eSPI bus, SMBus, of the computer system 300. The southbridge 370 connects to or includes within the management controller 380, Direct Memory Access (DMAs) controllers, Programmable Interrupt Controllers (PICs), and a real-time clock. In some instances, the southbridge 370 directly connects to the processor 340, such as in the case where the northbridge 360 is integrated into the processor 340. In some systems, the northbridge 360 and the southbridge 370 can be combined into a single die, such as for example into a platform controller hub (PCH).

The networking interface 350 is any interface that supports wired or wireless Local Area Networks (LANs) or Wide Area Networks (WANs), such as Ethernet, Fibre Channel, Wi-Fi, Bluetooth, Firewire, the Internet, etc. For example, the networking interface 350 can include a network interface controller (NIC) for Ethernet. Ethernet has been the most widely used networking standard for connecting computers in both Local Area Networks (LANs) and Wide Area Networks (WANs). Ethernet defines a number of wiring and signaling standards for the physical layer (PHY), through means of network access at the Media Access Control (MAC)/Data Link Layer, and through a common addressing format. Ethernet enabled devices typically communicate by transmitting data packets, which comprise blocks of data that are individually sent and delivered.

The various illustrative logical blocks, modules, and circuits described in connection with the disclosure herein can be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor is a microprocessor, or in the alternative, any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The operations of a method or algorithm described in connection with the disclosure herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor reads information from, and write information to, the storage medium. In the alternative, the storage medium is integral to the processor. The processor and the storage medium resides in an ASIC. The ASIC resides in a user terminal. In the alternative, the processor and the storage medium resides as discrete components in a user terminal.

In one or more exemplary designs, the functions described is implemented in hardware, software, firmware, or any combination thereof. If implemented in software, the functions are stored on or transmitted over as one or more instructions or code on a non-transitory computer-readable medium. Non-transitory computer-readable media includes both computer storage media and communication media including any medium that facilitates transfer of a computer program from one place to another. A storage media is any available media that can be accessed by a general purpose or special purpose computer. By way of example, and not limitation, such computer-readable media includes RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and blue ray disc where disks usually reproduce data magnetically, while discs reproduce data optically with lasers. Combinations of the above should also be included within the scope of non-transitory computer-readable media.

The previous description of the disclosure is provided to enable any person skilled in the art to make or use the disclosure. Various modifications to the disclosure will be readily apparent to those skilled in the art, and the generic principles defined herein can be applied to other variations without departing from the scope of the disclosure. Thus, the disclosure is not intended to be limited to the examples and designs described herein, but is to be accorded the widest scope consistent with the principles and novel features disclosed herein.

1. A method for remotely launching a deployment utility, comprising:
booting up a server;
performing a power-on self-test (POST);
determining a location of the deployment utility stored on a remote server;
retrieving the deployment utility from the remote server, based on the location; and
executing the deployment utility.

2. The method of claim 1, further comprising storing a Unified Extensible Firmware Interface (UEFI) bootable image to a UEFI bootable media, wherein booting up the server executes a script file on the UEFI bootable image comprising instructions for retrieving the deployment utility.

3. The method of claim 1, further comprising configuring, by a baseboard management controller (BMC) of the server, using an Intelligent Platform Management Interface (IPMI) command, to request the server to retrieve the deployment utility on a next boot up.

4. The method of claim 1, wherein executing the deployment utility installs an operating system to the server.

5. The method of claim 1, wherein executing the deployment utility installs firmware on the server.

6. The method of claim 1, wherein retrieving the deployment utility is by UEFI using iPXE or gPXE.

7. The method of claim 6, wherein retrieving uses at least one of Hypertext Transfer Protocol (HTTP), File Transfer Protocol, Internet Small Computer System Interface (iSCSI), or ATA over Ethernet (AoE) to transfer data from the remote server.

8. The method of claim 6, wherein booting up comprises loading an iPXE image and an embedded script from a bootable image, to update iPXE or gPXE settings.

9. The method of claim 1, wherein retrieving the deployment utility is by UEFI using Preboot eXecution environment (PXE) protocol.

10. The method of claim 9, wherein retrieving uses a Trivial File Transfer Protocol (TFTP) to transfer data from the remote server.

11. The method of claim 1, wherein the location of the deployment utility is entered by an administrator in an UEFI setup menu.

12. The method of claim 1, wherein the location of the deployment utility is a default address stored into UEFI during manufacturing.

13. A server for remotely launching a deployment utility, comprising:
a network interface card (NIC); and
a Unified Extensible Firmware Interface (UEFI) configured to:
perform a power-on self-test (POST);
determine a location of the deployment utility stored on a remote server;
command the NIC to retrieve the deployment utility from the remote server, based on the location; and
execute the deployment utility.

14. The system of claim 13, further comprising a UEFI bootable media storing a bootable image, wherein booting up the system executes a script file on the UEFI bootable image comprising instructions for retrieving the deployment utility.

15. The system of claim 13, further comprising a baseboard management controller (BMC) configured to use an Intelligent Platform Management Interface (IPMI) command to request the UEFI to retrieve the deployment utility on a next boot up.

16. The system of claim 13, wherein executing the deployment utility installs an operating system to the server.

17. The system of claim 13, wherein executing the deployment utility installs firmware on the server.

18. The system of claim 13, wherein the UEFI retrieves the deployment utility by using iPXE or gPXE.

19. The system of claim 13, wherein the UEFI retrieves the deployment utility by using UEFI using Preboot eXecution environment (PXE) protocol.
